(19) United States
(12) Patent Application Publication
(10) Pub. No.: US 2005/0005981 A1
(43) Pub. Date: Jan. 13, 2005

(54) Modular fluid components and assembly

(76) Inventors: Paul Eidsmore, Santa Cruz, CA (US); Gerhard H. Schiroky, Aurora, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/808,786

(22) Filed: Mar. 25, 2004

Related U.S. Application Data
(60) Provisional application No. 60/320,055, filed on Mar. 26, 2003.
(60) Provisional application No. 60/320,061, filed on Mar. 27, 2003.
(60) Provisional application No. 60/320,062, filed on Mar. 27, 2003.
(60) Provisional application No. 60/320,063, filed on Mar. 27, 2003.

(51) Int. Cl. F16K 27/00

(52) U.S. Cl. 137/884

(57) ABSTRACT

A modular fluid flow system is provided with selectable features. One feature is a substrate design that is sculpted or contoured to improve air flow when the substrate is installed in a modular system. Also provided is a valve concept in which a third port, such as a purge port, is formed coplanar with inlet and outlet ports of the valve, but the third port is not collinear with the other two ports. A mounting arrangement is provided that uses a releasable clamping feature to secure a substrate to support members, thereby avoiding threaded connections therebetween. Fluid component seal surfaces are also formed by work hardening methods to provide hard metal to metal seal surfaces even for soft bulk material such as cast metal.

### RELATED APPLICATIONS

This application claims the benefit of U.S. provisional patent application Ser. Nos. 60/320,055, MOUNTING ARRANGEMENT FOR MODULAR FLUID COMPONENTS filed Mar. 26, 2003; 60/320,061, PURGE VALVE FOR MODULAR FLUID FLOW CONTROL filed Mar. 27, 2003; 60/320,062, WORK HARDENED SEAL SURFACE INTEGRAL WITH SUBSTRATE filed Mar. 27, 2003; and 60/320,063, MOUNTING BLOCK ARRANGEMENT FOR MODULAR FLUID filed Mar. 27, 2003, the entire disclosures all of which are fully incorporated herein by reference.

### BACKGROUND OF THE INVENTION

This invention relates to component design and mounting arrangements for modular fluid flow control systems. In many industries, particularly the semiconductor manufacturing industry, critical fluids such as process gases must be transported within a facility without introducing contamination. These high purity systems involve a number of different flow control devices that are plumbed throughout a manufacturing site. Such systems can become unwieldy, making installation and modifications/repair costly and time consuming activities. In response to this problem, modular fluid flow control systems, sometimes referred to as “gas sticks”, are becoming more attractive as a design option. One exemplary system is described in pending published U.S. patent application Ser. No. 09/544,020 filed on Apr. 6, 2000 for MODULAR SURFACE MOUNT MANIFOLD ASSEMBLIES and published under publication no. US 2002/0000256 A1 on Jan. 3, 2002, the entire disclosure of which is fully incorporated herein by reference.

Modular designs typically include a series of down mount or surface mount components that are installed onto mounting plates, blocks or substrates, sometimes together called “sticks.” Various techniques may be used to establish fluid communication between the various surface mounted flow control devices. The sticks are then typically arranged lengthwise in a side by side manner and may be supported by bolting the sticks together or to additional support members. As a consequence, an assembler must install and tighten a number of bolts or other fasteners to securely install each stick to the support members. This makes assembly time consuming as it is important that all bolts be tightened to the proper torque. Additionally, bolt holes have to be provided for the sticks, and different system designs often have different hole patterns and lengths, making assembly of different components difficult or incompatible.

The substrates are often rectangular in shape, and when placed side by side with each other leave little or no room in between the substrates. The assembled substrates or sticks further are typically installed in a gas box or enclosure. Air is circulated through the box in order that minor leaks not contaminate the system. The closely spaced rectangular block design may represent a significant impediment to air flow within the gas box.

Because of the high fluid purity required, the fluid flow paths must oftentimes be purged. A purge cycle typically involves shutting off flow of the process fluid and then opening one or more purge valves that permit flow of a purge fluid through the flow path, for example, an inert gas. In modular systems, each flow control component is connected in fluid communication with a fluid flow path via a series of sealed ports at spaced component mounting locations. When a number of flow components are mounted on a substrate, it is common practice to make the mounting holes and port locations uniform in terms of spacing, size and location. This creates a problem for connecting a purge valve into the substrate because the purge valve requires an independent purge port that can be coupled to a purge line. Prior designs have attempted to solve this problem by running the purge flow path in a second substrate layer under the main substrate layer. However, the prior art purge valve typically requires three ports, one for inlet from the purge supply and two for connection with the passage, while the component mounting locations on the substrate have only two ports. The uniform port spacing and mounting holes on the substrate greatly restricts the ability to position or reposition a purge valve at specific locations on a substrate because the purge port extends through the same substrate structure as the main fluid flow path. Furthermore, the position of the purge port on a substrate may vary depending on the particular flow control device that is mounted to the substrate. Oftentimes then, a modification to the purge configuration involves a significant effort to rebuild the stick after a purge valve or purge line is installed or repositioned.

As illustrated in the referenced published disclosure, a typical surface mount substrate design includes two or more ports formed in the mounting surface of the substrate. These ports communicate with a fluid passageway associated with the substrate. The surface mounted components, such as valves, pressure regulators, mass flow controllers and so on have corresponding ports formed in the lower surface of the component base. The component base is bolted or otherwise attached to the substrate so that the ports in the component align with the ports in the substrate. In order to establish a fluid tight seal between the substrate and the surface mounted component, a metal C-seal is commonly used.

A conventional C-seal is an annular compressible seal that is partially received in a recessed cavity (counterbore) that surrounds the port in the substrate and the aligned port in the surface mounted component. When the two parts are joined together, the C-seal is compressed and forms a fluid tight seal that surrounds the ports and prevents leakage. C-seals may be installed using a suitable retainer device to ease assembly, again as described in the referenced publication.

The C-seal, when installed, engages a surface in the counterbore in the substrate and also engages a surface in the counterbore in the component that is being mounted on the substrate. These surfaces that the seal engages must meet specific hardness requirements, in order to obtain an effective metal to metal seal. For example, one user of such components requires a surface hardness of 102 Rockwell B Solution annealed. Stainless steel bar stock or plate does not have this hardness.

### SUMMARY OF THE INVENTION

The invention contemplates a number of concepts for improving the manufacturability and ease of use of modular fluid components and assembly. In accordance with one aspect of the invention, a substrate design is provided to facilitate circulation air flow. In one embodiment, a substrate is provided that is sculpted or geometrically configured to eliminate non-structural portions of the substrate block material, thus providing gaps and openings to facilitate air flow between adjacent substrate rows.

In accordance with another aspect of the invention, a mounting arrangement is provided that simplifies assembly of a modular system. In one embodiment, the mounting arrangement includes a releasable mechanism for securing a substrate to a base member.

In accordance with another aspect of the invention, a configuration is provided that simplifies the initial assembly an/or replacement or re-positioning of a three port component, or other component that utilizes a fluid inlet that communicates with a second fluid passageway. In one embodiment, a purge valve is provided having an off-axis input port that is position independent of the substrate configuration.

In accordance with another aspect of the invention, components of a modular system are provided with work hardened seal surfaces. In one embodiment, a substrate and method of manufacture are contemplated for providing at least one seal surface that is work hardened so that the resulting seal surface is harder than the bulk material of the substrate.

Although the invention is described herein in the exemplary embodiment as being used with a modular gas stick such as having a substrate and surface mounted component, such description is intended to be exemplary in nature and should not be construed in a limiting sense. The invention may be used with any arrangement in which it is desired to establish a fluid tight seal between any two ports that communicate a fluid, be it liquid, gas, emulsion or a slurry for example, therebetween.

These and other aspects and advantages of the invention are fully described herein and will be readily understood in view of the accompanying drawings.

### BRIEF DESCRIPTION OF THE DRAWINGS

FIG. 1 is an isometric illustration of an exemplary modular fluid flow control system in accordance with the invention;

FIG. 2 is a plan view of a stick or substrate that forms part of the system of FIG. 1;

FIG. 3 is a perspective view of the substrate of FIG. 2;

FIGS. 4-9 illustrate alternative substrate constructions;

FIG. 10 is an exploded elevational view of a substrate securing arrangement in accordance with the invention;

FIG. 11 is an assembled view of the substrate securing arrangement of FIG. 10, shown in an assembled but unclamped condition;

FIG. 12 is a view similar to FIG. 11, showing the substrate securing arrangement in a clamped condition;

FIG. 13 is a plan view of a drive block that forms part of the securing arrangement of FIG. 10;

FIG. 14 is a plan view of a driven block that forms part of the securing arrangement of FIG. 10;

FIG. 15 is a perspective view of a purge valve that forms part of the system of FIG. 1;

FIG. 16 is a sectional view showing the purge valve of FIG. 15 mounted on the substrate of FIG. 2;

FIG. 17 is a sectional view similar to FIG. 16 taken at ninety degrees to FIG. 16;

FIG. 18 is a bottom plan view of the purge valve of FIG. 15, taken generally along line 18-18 of FIG. 17;

FIG. 19 is a top plan view of the substrate and an associated purge fluid supply, taken generally along line 19-19 of FIG. 17;

FIG. 20 illustrates a seal region in cross-section;

FIGS. 21-22 illustrate structural changes resulting from a first work hardening, seal surface process;

FIG. 23 illustrates another seal region configuration in cross-section; and

FIGS. 24-28 illustrate structural changes resulting from alternative work hardening processes.

### DETAILED DESCRIPTION OF EMBODIMENTS OF THE INVENTION

1. Introduction

The invention contemplates various improvements including component design and methods of manufacture for modular fluid flow systems. Although the invention is illustrated with exemplary embodiments, those skilled in the art will readily appreciate that the various aspects and advantages and concepts of the present invention can be realized in many different forms, configurations and embodiments. The invention, for example, is not limited to any specific down mount component design, nor any specific substrate design, material or seals. Moreover, various aspects of the invention are described herein and are embodied in the exemplary embodiments. These various aspects however may be realized in alternative embodiments either alone or in various combinations and sub-combinations thereof. Some of these alternative embodiments will be described herein but such descriptions are not intended to be a complete or exhaustive list of available alternative embodiments, arrangements, configurations, materials or form, fit and function. Those skilled in the art may readily adopt one or more of the aspects of the invention into additional embodiments within the scope of the present invention even if such embodiments are not expressly disclosed herein. Additionally, even though some aspects and features may be described herein as being a preferred and/or exemplary arrangement, method, configuration, form, fit, function, materials and so on, such description is not intended to suggest that such feature is required or necessary unless so expressly stated.

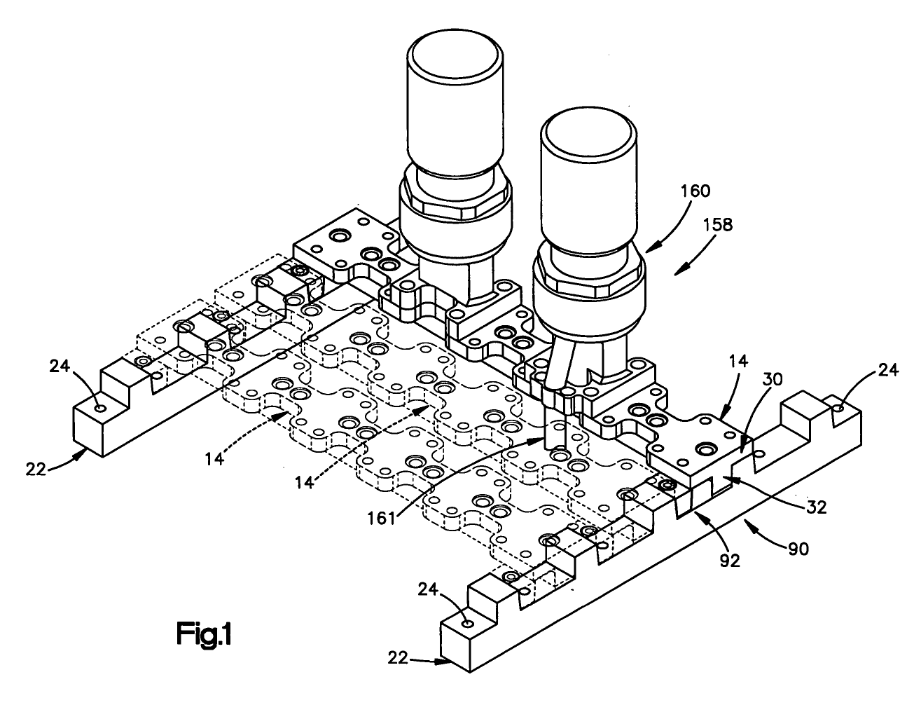

FIG. 1 illustrates a portion of a modular fluid flow control system 10. The modular system 10 typically includes one or more surface mounted flow components 12, which may include but are not limited to valves, meters, mass flow controllers, pressure regulators, transducers, sensors and so on. The flow components 12 are mounted to elongated substrates or sticks 14 (three are shown in FIG. 1, namely 14a, 14b and 14c) by the use of bolts 16 or other suitable fastener or securing arrangements. No aspect of the invention is not limited to any particular design aspect of the flow components except as otherwise described herein.

Each substrate 14 may support one or more flow components 12, and typically will be used for a specific gas or fluid, although the substrates need not carry different fluids. Each one of the substrates 14 includes at least one flow passage or path 18 (FIG. 3) for providing fluid communication between the various flow components 12 through an array of inlet and outlet ports 20 located along an axis 36 of the substrate. In the exemplary embodiments herein the flow paths 18 are channels formed within the substrates 14.

Support members in the form of side rails 22 are provided to securely support the substrates 14. Two such side rails 22 are illustrated in FIG. 1. For ease of illustration and clarity the side rails 22 are illustrated as being positioned at the longitudinal edges, or ends, of the substrates 14. This need not be the case, however. One or more of the substrates 14 may extend lengthwise past either or both side rails 22, and furthermore there may be more than two side rails used, particularly for long substrates. The side rails 22 may include through holes 24 or other suitable arrangements for mounting the side rails to another structure, such as for example a panel or housing.

2. Substrate Profile

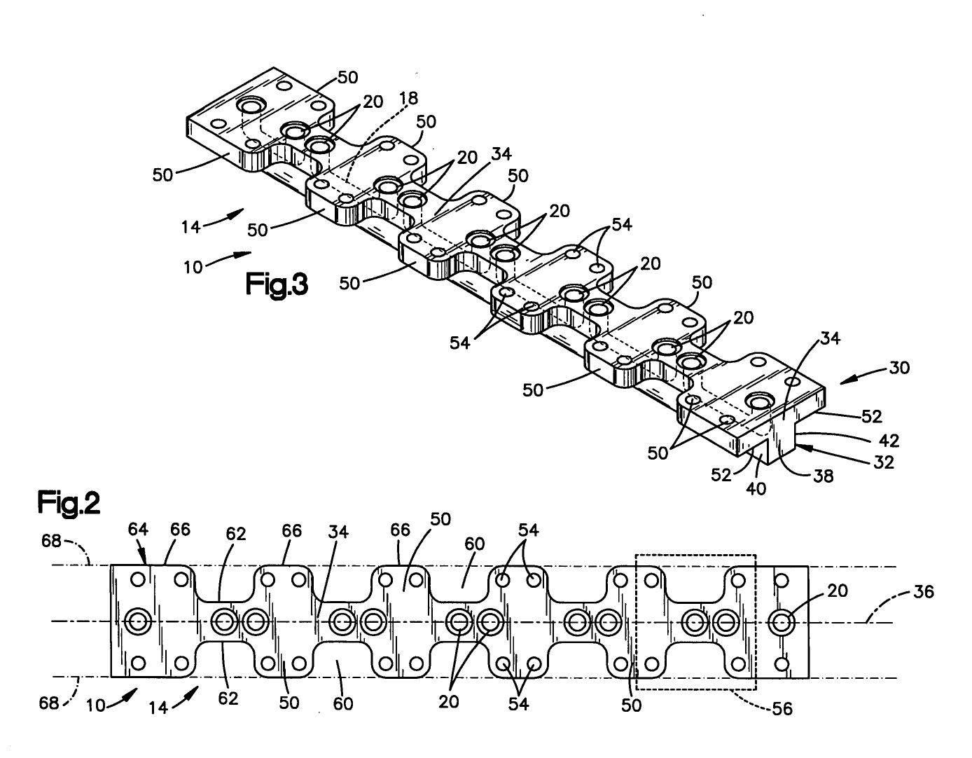

FIGS. 2-9 illustrate one aspect of the invention by which, in order to improve air flow in and around the various side by side assembled sticks or substrates 14 (see FIG. 1), each substrate or at least some of the substrates are sculpted or profiled (configured) so as to remove portions of the block material that are structurally unnecessary.

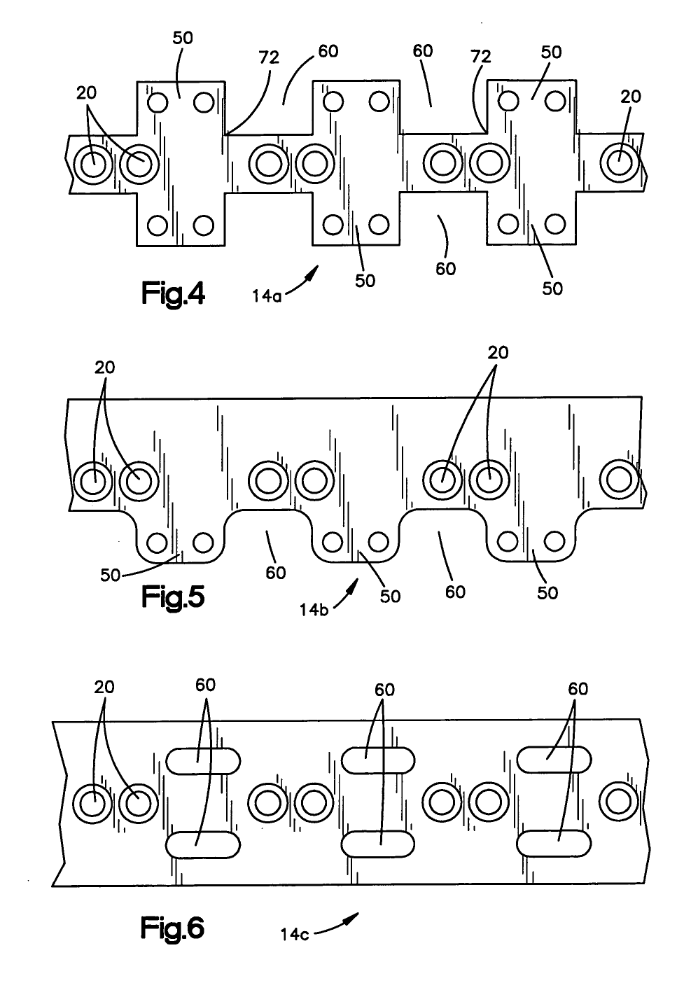

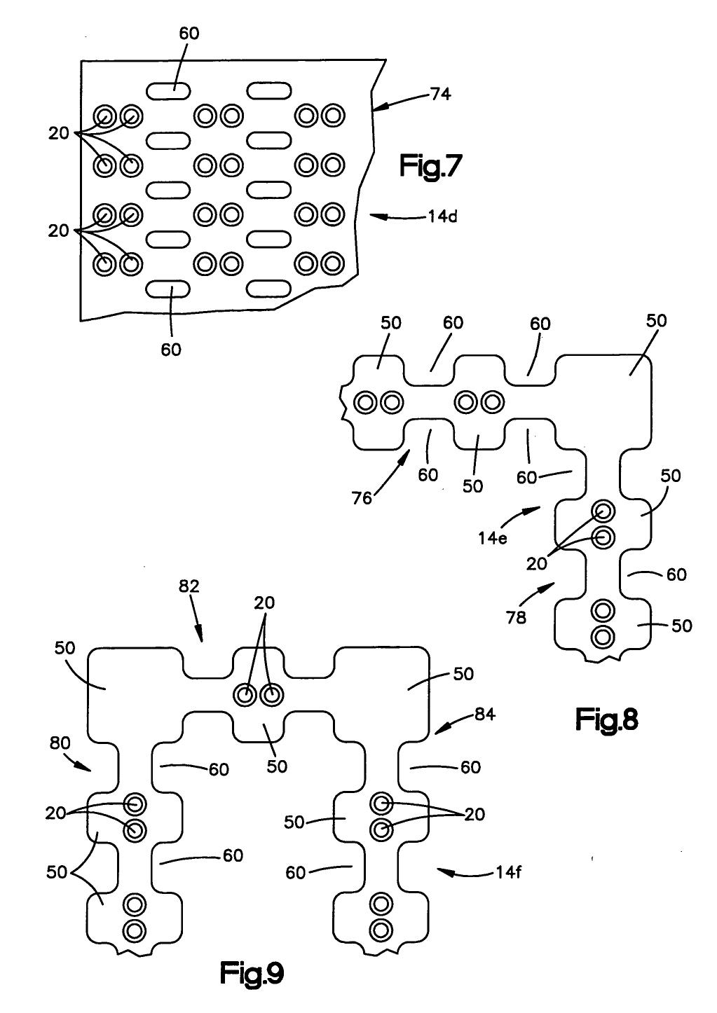

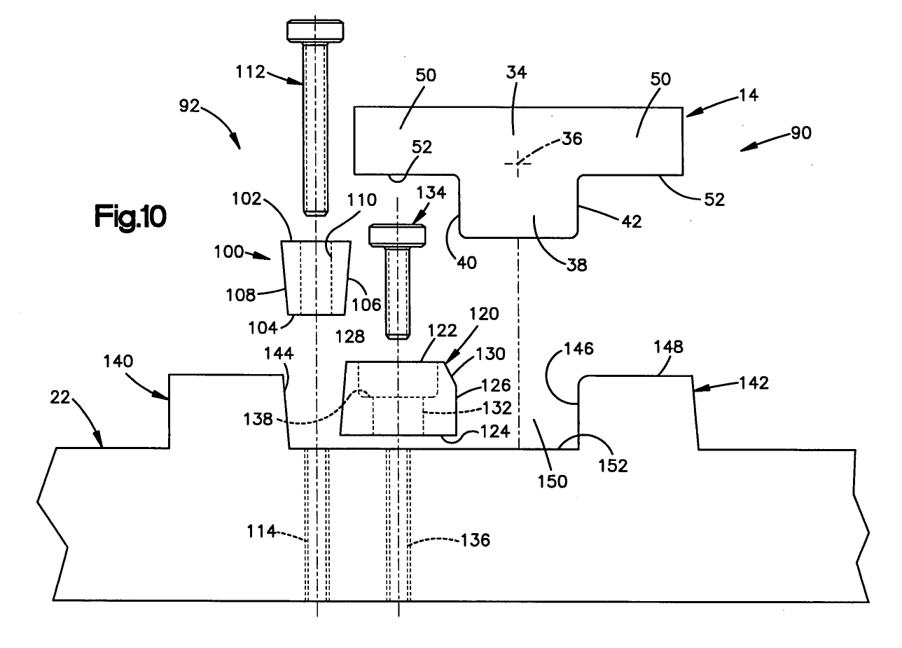

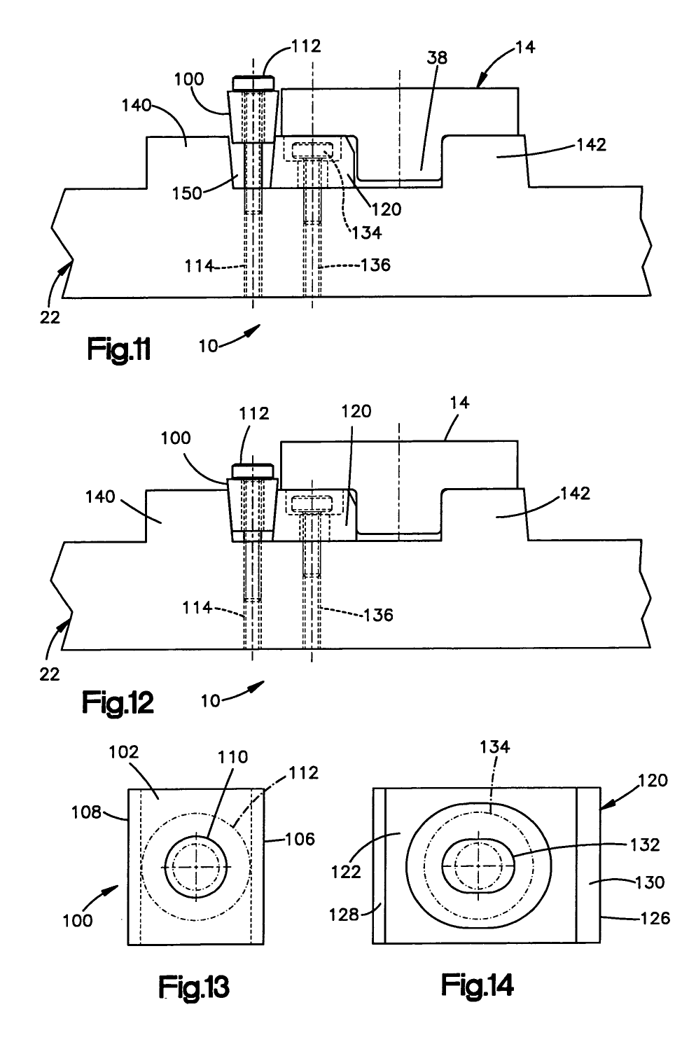

The particular substrate 14 that is illustrated in FIGS. 3 and 4 has a generally T-shaped cross-sectional configuration including an upper or horizontal arm 30 and a lower or vertical arm 32. The terms horizontal and vertical herein are merely terms of convenience and do not imply any particular orientation of the assembly in actual use. The horizontal arm 30 includes a longitudinal central portion 34 of the substrate 14 that extends along the central axis 36 of the substrate. The vertical arm 32 includes a central longitudinal rib 38 that extends under the longitudinal central portion 34 of the substrate. The rib 38 has opposite side surfaces 40 and 42. The rib 38 may be formed either by machining or in a casting/molding process of the substrate 14. The rib may alternatively be separately formed and attached to the upper arm 30. The rib 38 provides structural support for the central portion 34 of the substrate 14. The rib 38 also defines and encloses the flow passages 18 that extend along part or all of the length of the substrate 14. The ports 20 are formed in the central portion 34 of the substrate 14 and communicate with a respective flow passage 18.

The horizontal arm 30 of the T-shaped substrate 14 also includes a plurality of lateral lands or projections 50 that extend from the longitudinal central portion 34 of the substrate. The lands 50 have lower side surfaces 52 that extend perpendicular to the side surfaces 40 and 42 of the rib. Four bolt holes (for example) 54 are machined or otherwise formed in each set of lands 50. The lands 50 form or define component mounting portions 56 of the substrate 14 for mounting flow components 12 of the system 10. Each component mounting portion 56 includes a contiguous portion of the substrate 14 that includes four bolt holes 54 and two ports 20.

The substrate 14, in the area laterally outward of the central portion 34, need only have sufficient material in the areas of the bolt holes 54 to securely receive the bolts 16 (FIG. 1) that are used to secure the surface mounted components 12 to the substrate 14. Therefore, between the lands 50, the material of the substrate 14 is either machined away, or the substrate molded or cast to a desired form. As a result, a plurality of air slots, openings or passageways 60 are formed in the substrate 14, between the lands 50.

When the substrate 14 is thus formed, the central portion 34 of the substrate 14 has parallel outer side surfaces 62 that are interrupted by the lands 50. The substrate 14 as a whole has an outer sculpted side surface 64. The outer side surface 64 comprises individual outer side surfaces 66 of the lands 50 that are disposed in a longitudinal array along lines 68 that extend parallel to the axis 36 and that are spaced transversely (laterally outward) from the central portion 34 of the substrate 14. The outer side surface 64 of the substrate 14 as a whole is interrupted by the passageways 60 to form the individual outer side surfaces 66 of the lands 50. The passageways 60 are bounded by the lands 50 and by the outer side surfaces 62 of the central portion 34 of the substrate 14.

When two or more substrates 14 are mounted adjacent each other on support members such as the side rails 22, the sculpted openings or passageways 60 provide substantial space through which air can be circulated. This can be important in closely enclosed fluid flow component systems 10 such as a gas box where it is necessary to provide adequate ventilation and when it is desirable, for space considerations, to mount two or more substrates 14 side by side or close together. Better air flow between components 12 means a lower volume of air that needs to be forced through the system 10, and also provides improved exhaust of any leaked gases. In addition, the openings 60 can provide space for parts that are not arranged along the linear extent of the substrates 14, for example, down mount components that can be placed between the substrates. Additionally, the sculpted substrate 14 has less mass than a comparable substrate that does not have the passageways 60. The lower mass can make the part easier to handle, and also less expensive to manufacture in terms of material costs.

FIGS. 4-9 illustrate alternative embodiments of substrates constructed in accordance with this aspect of the invention. The substrates illustrated in FIGS. 4-9 have differing overall configurations but each includes passageways 60 for air circulation as described above.

Specifically, FIG. 4 illustrates a portion of a substrate 14a in which the corners 72 of the passageways 60 are squared off rather than curved as in the embodiment of FIGS. 2 and 3. FIG. 5 illustrates a substrate 14b in which passageways 60 are formed on only one side of the substrate, rather than on both sides as in the embodiment of FIGS. 2 and 3. FIG. 6 illustrates a portion of a substrate 14c in which passageways 60 are formed as holes or openings in the material of the substrate, surrounded on all sides by material of the substrate, rather than as cutouts open on one side as in the embodiment of FIGS. 2 and 3.

FIG. 7 illustrates a portion of a substrate 14d in the form of a platter 74. The platter 74 includes structure similar to that found in a plurality (in this case, at least five) of the substrates 14 (FIGS. 2 and 3). Thus, the platter 74 may be considered to be the functional equivalent of a plurality of adjacent substrates 14. The platter 74 may be mounted on the side rails 22 in the system shown in FIG. 1. Vent openings 60 are formed in the platter 74 for enhancing cooling and venting as described above.

FIG. 8 illustrates a portion of a substrate 14d having a generally L-shaped configuration including first and second legs 76 and 78. Each one of the first and second legs 76 and 78 includes structure similar to that found in one of the substrates 14 (FIGS. 2 and 3). Passageways 60 are formed in each one of the legs 76 and 78 of the substrate 14d for enhancing cooling and venting as described above.

FIG. 9 illustrates a portion of a substrate 14e having a generally U-shaped configuration including three legs 80, 82 and 84. Each one of the legs 80-84 includes structure similar to that found in one of the substrates 14 (FIGS. 2 and 3). Passageways 60 are formed in each one of the legs 80-84 of the substrate 14d for enhancing cooling and venting as described above.

The exact shape and geometry of the sculpted openings (passageways) 60 can be selected based on the particular air flow requirements and substrate design needed for a particular application. The embodiments illustrated herein are intended to be exemplary in nature and should not be construed in a limiting sense.

3. Releasable Mounting Arrangement

With reference to FIGS. 1 and 10-14, a mounting arrangement 90 in accordance with another aspect of the invention is shown for mounting one of the substrates 14 to one of the side rails 22, it being recognized that the basic assembly technique and hardware may be but need not be used throughout the assembly 10—along the length of both side rails.

In an exemplary form, the mounting arrangement 90 includes a base member, which in this case is provided by the side rail 22; a portion (the rib 38) of the substrate 14; and a securing arrangement 92 that secures the substrate 14 to the base. The securing arrangement 92 allows for easy assembly of the substrate 14 to the base and for easy removal of the substrate from the base.

In the exemplary embodiment, as described below, the securing arrangement 92 provides a clamping action between the substrate 14 and the side rail 22. The clamping action eliminates the need for threaded fasteners or other interconnections between the substrate 14 and the side rail 22. Thus, there is no hole pattern alignment required. Also, there is no relative length restriction between the length of the substrate 14 and the location of the side rail 22—that is, the substrate can be clamped to the side rail at any position along the length of the substrate. In cases where only two side rails 22 are used, a single substrate 14 may be removed from the system 10 by simply loosening two bolts, without removing them and allowing them to come free, as is described below.

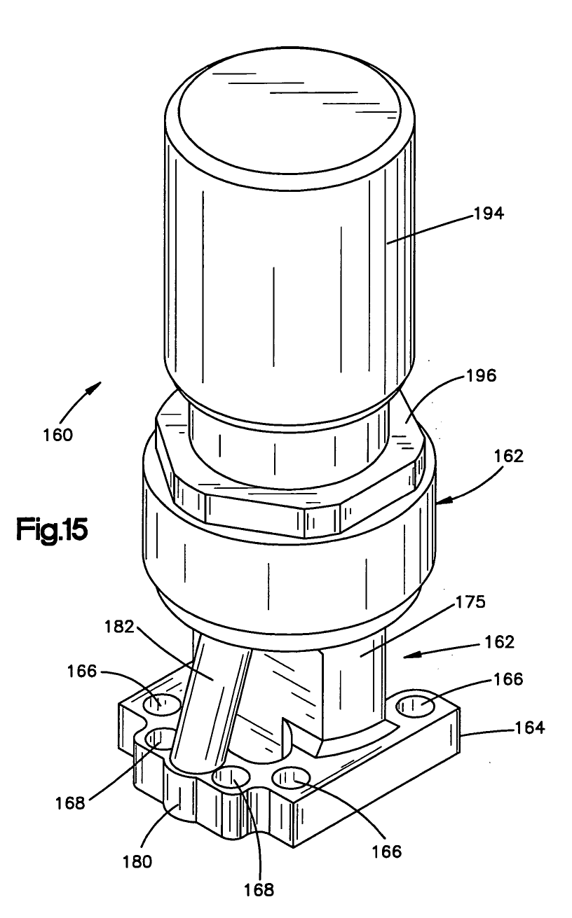

The securing arrangement 92 (FIGS. 10-14) in the exemplary embodiment includes a drive member or drive block 100. The drive block 100 is in the form of a wedge having parallel upper and lower surfaces 102 and 104. The drive block 100 has opposite inner and outer side surfaces 106 and 108 that are not parallel to each other and that are not perpendicular to the upper and lower surfaces 102 and 104. In the illustrated embodiment, the side surfaces 106 and 108 of the wedge 100 extend at an angle of about 5 degrees to the vertical, so that the upper surface 102 of the wedge is longer (from left to right as viewed in FIG. 15) than the lower surface 104 of the wedge.

The drive block 100 has a through hole 110 that extends vertically between the upper and lower surfaces 102 and 104 of the drive block. The through hole 110 is sized to accept a bolt 112 freely. The bolt 112 is threaded to cooperate with a tapped bolt hole 114 in the side rail 22.

The securing arrangement 92 also includes a driven block 120 that has parallel upper and lower surfaces 122 and 124. The height of the driven block 120, that is, the distance between its upper and lower surfaces 122 and 124, is slightly greater than the height of the rib 38 of the substrate 14.

The driven block 120 has opposite inner and outer side surfaces 126 and 128 that extend between the upper and lower surfaces 122 and 124. The outer side surface 128 is not perpendicular to the upper and lower side surfaces 122 and 124 but rather extends at an angle thereto. In the illustrated embodiment, the outer side surface 128 extends at an angle to the vertical that is the same as the angle of the inner side surface 106 of the wedge 100, that is, at 5 degrees off vertical. Thus, the outer side surface 128 of the driven block 120 is complementary to the inner side surface 106 of the wedge 100.

The inner side surface 126 of the driven block 120 extends generally perpendicular to the upper and lower surfaces 122 and 124 of the driven block. The corner of the driven block 120 may be cut away as at 130 for clearance. The width of the driven block 120, between the two side surfaces 126 and 128, is preferably a little greater than the width of one of the lands 50 on the substrate 14.

The driven block 120 has a through hole 132 that extends vertically between the upper and lower side surfaces 122 and 124 of the driven block. The through hole 132 is sized to accept a bolt 134 freely. The through hole 132 is slightly larger in diameter than the shank of the bolt 134. Alternatively, the through hole 132 may be oval or otherwise elongated in configuration in a direction along the length of the side rail 22, as shown in FIG. 14. The bolt 134 is threaded to cooperate with another tapped bolt hole 136 in the side rail 22. The upper surface 122 of the driven block 120 preferably has a counterbore 138 to allow the head of the bolt 134 to be recessed below the upper surface of the driven block.

The side rail 22 has two upstanding wall portions 140 and 142 that are spaced apart along the length of the side rail and that define a substrate mounting location on the side rail. The first wall portion 140 has an inner surface 144 that extends at an angle to the vertical that is preferably but not necessarily complementary to the angle of the outer side surface 108 of the wedge 100, that is, about 5 degrees from the vertical in the illustrated embodiment. The second wall portion 142 has an inner surface 146 that faces the angled surface 144 of the first wall portion 140 and that extends generally perpendicular to the horizontal to form a blocking portion of the side rail 22. The second wall portion 142 also has an upper side surface 148. A channel or groove 150 in the side rail 22 is defined between the two wall portions 140 and 142 and an upper side surface 152 of the side rail 22 and defines the aforementioned substrate mounting location on the side rail 22. The two bolt holes 114 and 136 in the side rail 22 are located between the first and second wall portions 140 and 142 and open into the channel 150.

The driven block 120 is located in the channel 150, on the upper surface 152 of the side rail 22. The bolt 134 extends through the through hole 132 in the driven block 120 and is threaded into the bolt hole 136 in the side rail 22. The head of the bolt 134 is recessed below the upper surface 122 of the driven block 120. The bolt 134 is tightened sufficiently to block vertical movement of the driven block 120 off the side rail, but is not tightened down completely. As a result, the driven block 120 is slidable along the side rail because of the oversize or elongate nature of the through hole 132 in the driven block.

The drive block 100 also is located in the channel 150, between the driven block 120 and the first wall portion 140. The bolt 112 extends through the through hole 110 in the drive block 100 and is threaded into the bolt hole 114 in the side rail 22. The bolt 112 is not tightened completely into the side rail 22. The head of the bolt 112 extends above the upper surface 102 of the drive block 100. Because the bolt 112 is not tightened completely, the drive block 100 is movable vertically relative to (toward and away from) the side rail 22.

The drive block 100 rests on the first wall portion 140 of the side rail 22 and on the driven block 120, at a location off the upper surface 152 of the side rail. Specifically, the angled outer side surface 108 of the drive block 100 is in abutting engagement with the angled inner side surface 144 on the first wall portion 140 of the side rail 22. The angled inner side surface 106 of the drive block 100 is in abutting engagement with the angled outer side surface 128 of the driven block 120.

To assemble the substrate 14 to the side rail 22, the substrate is placed in association with the side rail as shown in FIG. 16. The rib 38 of the substrate 14 is placed between the driven block 120 and the second wall portion 142 of the side rail 22. One side surface 40 of the rib 38 is in abutting engagement with the inner side surface 126 of the driven block 120. The other side surface 42 of the rib 38 is in abutting engagement with the inner side surface 120 of the second wall portion of the side rail. The lower side surface 52 of one land 50 of the substrate 14 rests on the upper surface 122 of the driven block 120. The lower side surface 52 of the opposite land 50 of the substrate 14 rests on the upper surface 148 of the second wall portion 142 of the side rail 22. The rib 38 of the substrate 14 is located in the channel 150 of the side rail 22, preferably spaced upward from and off the upper surface 152 of the channel.

The bolt 112 that extends through the drive block 100 is then screwed farther into the bolt hole 144 in the side rail 22. As a result, the bolt 112 moves axially, that is, in a downward direction as viewed in FIGS. 11 and 12. The head of the bolt 112 transmits force to the drive block 100 in this downward direction, causing the drive block to move downward also. The drive block 100 is wedged between the first wall portion 140 of the side rail 22 and the driven block 120.

The angled surfaces 106 and 108 of the drive block 100 cooperate with the angled surfaces 144 and 128 of the first wall portion 140 and of the driven block 120, respectfully, to exert laterally outwardly directed force on both the first wall portion and on the driven block. Because the first wall portion 140 of the side rail 22 is fixed in position while the driven block 120 is movable, this force causes the driven block to slide laterally along the side rail, in a direction to the right as viewed in FIGS. 11 and 12, toward the second wall portion 142 of the side rail.

The lateral sliding movement of the driven block 120 causes the rib 38 of the substrate 14 to be captured and clamped between the driven block and the second wall portion 142 of the side rail 22. The angled threaded connection between the bolt 112 and the side rail 22 provides a significant mechanical advantage in producing this clamping force when the bolt 112 is rotated. In addition, the engagement of the angled surfaces of the drive block 100, the driven block 120, and the first wall portion 140 of the side rail 22, also provides a significant mechanical advantage in producing this clamping force when the bolt 112 is rotated. As a result, a relatively light rotational force on the drive bolt 112 produces sufficient clamping force on the substrate rib 38 to hold the substrate 14 and its associated components 12 securely in place on the side rail 22.

To release the substrate 14 from the side rail 22, the bolt 112 is loosened, that is, partially unthreaded from the side rail 22. When the bolt 112 is thus loosened, the clamping force on the rib 38 of the substrate 14 is reduced and the substrate can be removed from the side rail 22. This removal can be accomplished simply by lifting the substrate 14 straight up, as there are no mounting bolt holes or mounting bolts extending vertically through the substrate. It is not necessary to remove the bolt 112 completely from the side rail 22 or the drive block 100, but only to loosen it. Therefore, the drive bolt 112 remains captive on the side rail 22, and does not need to be fully backed out which might cause it to be misplaced. When a substrate 14 is thereafter to be assembled again to that particular substrate mounting location on the side rail 22, no loose parts must be found.

Only a single bolt 112 is required to be tightened and loosened to install and remove one end of the substrate 14. Thus, only two bolts 112 are needed to mount an entire substrate 14 at both ends. No bolt hole alignments are needed with the substrate 14. The driven block bolt 134 holds the driven block 120 to the side rail 22 when a substrate 14 is not installed at a particular location.

The clamping of the rib 38 of the substrate 14 also eliminates the need for threaded fasteners or other interconnections between the substrate and the side rail 22. Thus, there is no hole pattern alignment required. Further, there is no relative length restriction between the length of the substrate 14 and the location of the side rail 22—that is, the substrate can be clamped to the side rail at any position along the length of the substrate. In cases where only two side rails 22 are used, a single substrate 14 may be removed from the system 10 by simply loosening two bolts Other securing arrangements are usable. For example, a different portion of the substrate 14 might be clamped. The invention also can be used with a substrate 14 having other than a T-shaped configuration. For example, the invention is applicable to a system 10 in which the clamp engages the sides of a generally rectangular substrate 14. Thus, the securing assembly shown in the drawings is only illustrative of the invention.

4. Flow Components With Off-Axis Port

With reference again to FIG. 1, each substrate 14 preferably includes a purging arrangement 158 in the form of a purge valve 160 (for each of the substrates 14a, 14b and 14c there is a respective purge valve 1 and a purge supply 161. Not every substrate 14 may require a purge capability, depending on the design of the particular flow control system 10.

In accordance with one aspect of the invention, the purging arrangement 158 is designed such that purging fluid can be introduced into the primary or main fluid flow path 18 of a substrate 14 that supports the purge valve 160 without having to pass through a port 20 or conduit in the substrate. A purge valve requires a third port or fluid inlet, in addition to the two ports found in other components 12. As described below, the purge fluid inlet of the purge valve 160 is located off the axis 36 of the substrate 14, so that uniform inlet and outlet port locations 20 may be used at all component mounting locations 56 along the length of the substrate, and no specific portion of the substrate needs to be modified so as to be dedicated for use with a purge valve. As a result, a purge valve 160 may be positioned at any location along the length of the substrate 14 that is convenient for running the purge line. This design also facilitates installing or repositioning a purge valve 160 on a substrate 14 without having to rebuild or modify the basic substrate assembly.

The purge valve 160 includes a base or valve body 162. The purge valve base 162 includes a mounting flange 164 that has four fastener openings or bolt holes 166 at its four corners. The mounting flange 164 has a configuration that mimics the configuration of the mounting flanges of other components 12 to be mounted on the substrate 14. Thus, the purge valve 160 is adapted to fit exactly into any one of the series of identical component mounting locations 56 along the length of the substrate 14. The bolt holes 166 in the flange 164 are adapted to overlie the bolt holes 54 in the component mounting location 56 of the substrate 14. The flange 162 also includes two mounting holes 168 that receive bolts (not shown) for connecting the purge supply 161 to the flange 112.

The flange 162 includes a process fluid inlet port 170 and a process fluid outlet port 172. The spacing of the outlet and inlet ports 170 and 172 is preferably arranged to be uniform with that of other surface mounted components 12 of the system 10. Thus, the purge valve 160 can be mounted at any one of the plurality of component mounting locations 56 along the length of the substrate 14, and have its outlet and inlet ports 170 and 172 align with the ports 20 on the substrate 14 to enable fluid communication with the flow channel 18.

The inlet port 170 communicates with an inlet passage 174 in a pedestal 175 of the valve base 162. The outlet port 170 communicates with an outlet passage 176 in the pedestal 175 of the base 162. The inlet passage 175 and the outlet passage 176 are connected with each other within the valve base 162. As a result, the purge valve 160 enables free flow of fluid between the inlet port 170 and the outlet port 172 whenever the purge valve is mounted on the substrate 14.

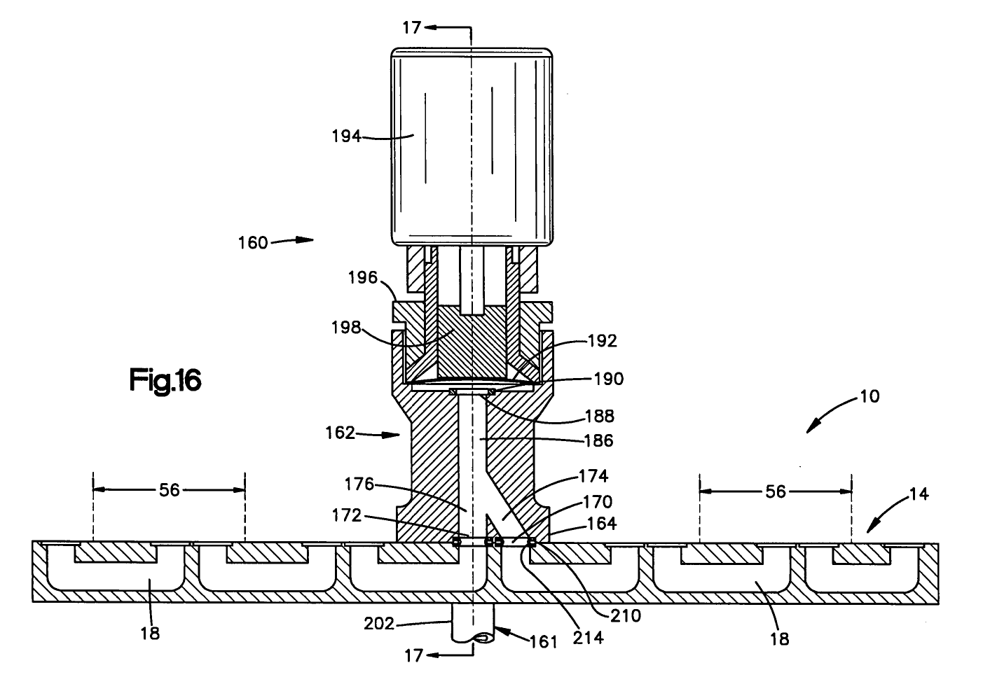

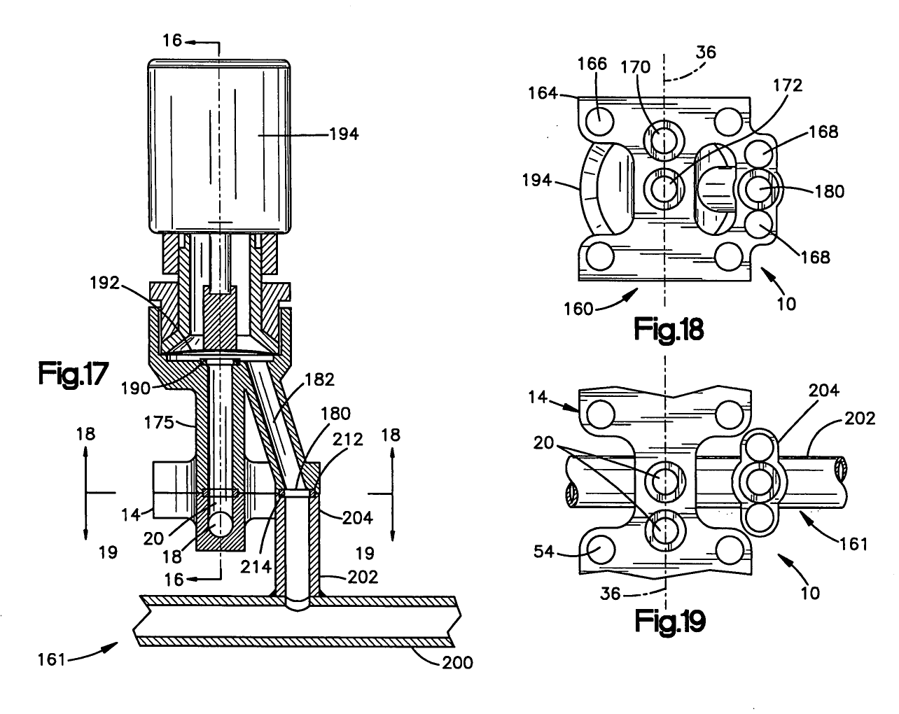

The mounting flange 164 of the purge valve base 162 also includes a purge fluid inlet port 180. The purge inlet port 180 is connected by a purge fluid passage 182 with a valve chamber 184 in the valve body 162. The purge fluid passageway 182 extends at an angle outward from the pedestal 175 to the inlet port 180, as can be seen in FIGS. 15 and 17, in a direction away from the axis 36 of the substrate 14.

Preferably, but not necessarily, the purge fluid passage 182 is integral to the base 162. Due to the relative complexity of the base 162, it is contemplated that the base 162 be formed by a casting or molding process, rather than by machining, to reduce cost. However, any suitable process may be used as required. The base 162 in one embodiment may be made from aluminum or plastic, although other materials can be used.

An internal passage 186 in the base 162 connects the valve chamber 184 with the inlet and outlet passages 174 and 176. The internal passage 186 terminates in a purge outlet port 188 at the chamber 184. A valve seat 190 on the valve body 162 extends around the purge outlet port 188.

The purge valve 160 includes a movable valve member in the form of a flexible diaphragm 192. The diaphragm 192 is fixed at its outer periphery to the valve base 162. A central portion of the diaphragm 192 is located near the valve seat 190 and is movable relative to the valve seat when the valve 160 is opened and closed, as described below.

The purge valve 160 further includes a valve actuator 194 mounted on the valve body 162. The actuator 194 may be automatic or manual and may be pneumatic, hydraulic, etc. A nut 196 or other suitable arrangement may be used to join the valve actuator 194 to the valve body 162. The actuator 194 is operable to move a valve stem 198 to displace the diaphragm 192 so as to open and close the purge outlet port 188.

The exemplary purging arrangement 158 that is shown in the drawings includes the purge supply 161, which may be for example a fluid passageway provided by tubing 200 and a drop down fitting 202. The drop down fitting 202 is simply a fluid connection that establishes fluid communication between the purge line 200 and the purge inlet port 180 of the purge valve 160. An exemplary drop down fitting is shown in the above referenced patent application, although any suitable fitting or connection may be used. Preferably, although not necessarily, the drop down fitting 202 includes a purge supply support flange or base 204. The purge supply base 204 is configured to mate with and be connected with the base flange 162 of the purge valve 160. Preferably the connection between the purge supply base 204 and the purge valve base 162 is a releasable connection such as with threaded bolts (not shown), although other connection and coupling arrangements may be used as required. A suitable seal mechanism is provided between the purge supply base 110-204 and the purge valve base 162 to provide a fluid tight seal therebetween. In this manner, fluid communication is established between the purge supply line 200 and the purge inlet port 180 of the purge valve 160.

The base 162 of the purge valve may further include appropriate seal grooves 210 that surround the inlet and outlet ports 170 and 172, and align with corresponding seal grooves (not shown) in the substrate 14 to establish a fluid tight seal and communication between the valve 160 and the fluid passageways 18 in the substrate 14. A similar seal groove 212 surrounds the purge inlet port 180 and that corresponds to a seal groove in the purge supply base 204. The grooves 210 and 212 may receive a suitable compression seal 214 such as an o-ring, a C-seal or any other suitable seal device.

When the valve 160 is in a closed position, not shown, the actuator 194 causes the central portion of the diaphragm 192 to seal against the valve seat 190. As a result, fluid communication is blocked between the valve chamber 184 and the inlet and outlet ports 170 and 172. Thus, purge fluid from the purge supply 161 can not enter into the flow path 18 of the substrate 14 via the inlet or outlet ports 172 and 174 of the purge valve 160.

In order to admit purge fluid into the flow path 18 in the substrate 14, the purge valve 160 is actuated. The actuator 194 causes the central portion of the diaphragm 192 to come off the valve seat 190. As a result, the purge fluid passageway 192 in the purge valve 190 is placed in fluid communication, through the valve chamber 184, with the inlet and outlet ports 170 and 172 of the valve base 162. Purge fluid can flow from the purge conduit 200 through the fitting 202 into the purge valve 160 and thence into the fluid passage 18 in the substrate 14. When the purging process is completed, the valve 160 is again actuated to close the purge outlet port 188.

The purge system of the present invention is not dependent on the inlet and outlet porting arrangement of the valve base 162, nor on the mounting arrangement of the base to the substrate 14. Specifically, the fluid inlets and outlets 20 that are disposed along the substrate 14, are all disposed in a single linear array extending parallel to the axis 136 and to the length of the substrate 14. The purge inlet port 180 is not aligned with that linear array or axis 136. Instead, the purge inlet port 180 is spaced apart from the linear array of ports 20 in a direction generally normal to the length of the substrate 14. This results from the purge fluid passageway 182 extending at an angle outward from the pedestal 175, as can be seen in FIGS. 15 and 17, in a direction away from the axis 136 and the array of ports 20. As a result, the purge inlet port 180 is located off the substrate 14, out of the envelope of the substrate. The purge supply 161 can therefore be provided by a down mount assembly as shown in FIG. 1. The down mount assembly can be located between and extend in the open space between two substrates 14 that are mounted side by side on the side rails 22.

The purge valve 160 can be located at any one of the plurality of identical component mounting locations 56 along the length of the substrate 14, because its third port (the purge port 180) is connected off the substrate. The purge valve base or flange 162 thus, in effect, decouples, or separates, the connection of the purge valve 160 with the purge supply 161 from the mounting arrangement of the purge valve 160 to the substrate 14. In addition, the purge supply passage 182 into the purge valve 160 does not pass through the pedestal 175, but rather only through the flange 162. In other words, the purge valve 160 is mounted on the substrate 14 using the same uniform inlet and outlet porting arrangements and mounting holes as any of the other fluid components 12 that are used in the system. Thus, a purge valve 160 may be positioned or repositioned on the substrate 14 without having to involve a rebuild of the substrate 14 itself. The purge supply 161 can then simply be plumbed in any convenient fashion or layout. For example, one purge valve 160 can be positioned on one substrate 14 at a different position from a purge valve 160 on an adjacent substrate 14, with fluid connections between them that do not extend through the substrates 14, in a manner similar to a jumper wire on a circuit board.

5. Hardened Seal Surfaces

In accordance with another aspect of the invention, seal surfaces of one or more components of a modular fluid system, such as the system 10, are work hardened. This aspect of the invention is described with reference to FIG. 20.

FIG. 20 illustrates in cross-section a seal region of the system 10, for example, the seal region shown in FIG. 16. A first component 220 is shown associated with a second component 14. The first component 220 may be a base (mounting) portion of a valve, a purge valve as shown in FIG. 16, a flow control device, a pressure regulator, a flow restrictor or another type of surface mount flow control device, for example. The second component 14 as illustrated is a substrate, such as the substrate shown in FIG. 16.

The illustrated portion of the substrate 14 includes one of the ports 20 (FIG. 2). The port 20 includes a cylindrical surface 222 defining a bore or fluid passage 224 in the substrate 14. The bore 224 communicates with the fluid passage 18 (FIG. 16) in the substrate 14 and extends through an outer or upper surface 226 of the substrate. The bore 224 has a cylindrical configuration centered on an axis 230.

The port 20 on the substrate 14 also includes a recess 232, which in the illustrated embodiment is formed as a counterbore in the upper surface 226 of the substrate. The recess 232 is defined by a cylindrical, axially extending surface 234 and an annular, radially extending surface 236. The recess 232 extends around the bore 224. The radially extending surface 236 of the recess 232 forms a seal surface of the substrate 14.

The component 220 has a similar port and recess. Specifically, the illustrated portion of the component 220 includes a port 240. The port 240 includes a cylindrical surface 242 defining a bore or fluid passage 244 in the component 220. The bore 244 extends through an outer or lower surface 246 of the component 220. The bore 244 has a cylindrical configuration centered on the axis 230.

The port 240 also includes a recess 247, which in the illustrated embodiment is formed as a counterbore in the lower surface 246 of the component 220. The recess 247 is defined by a cylindrical, axially extending surface 248 and an annular, radially extending surface 250. The recess 247 extends around the bore 244. The radially extending surface 250 of the recess 247 forms a seal surface of the component 220.

When the component 220 is mounted on the substrate 14, the part 240 of the component is aligned with (coaxial with) the part 20 of the substrate 14. The seal surface 250 of the component 220 extends parallel to and is spaced apart from the seal surface 230 of the substrate 14. The two seal surfaces 236 and 250, along with the two cylindrical surfaces 234 and 248, define a seal cavity 252.

A C-seal or other suitable seal 254 is disposed in the seal cavity 252. The C-seal 254 is compressed axially between the seal surface 250 of the component 220 and the seal surface 236 of the substrate 14. The C-seal 254 seals between the component 220 and the substrate 14 so that fluid (gas) flowing between the bore 244 of the component and the bore 224 of the substrate does not leak out between the upper surface 226 of the substrate and the lower surface 246 of the component. The C-seal 254 is made from metal, and thus a metal to metal seal is effected between the C-seal and the seal surface 250 of the component 220. Similarly, a metal to metal seal is effected between the C-seal 254 and the seal surface 236 of the substrate 14.

In use of the system 10, the parts shown in FIG. 20 may be taken apart and reassembled, often with new C-seals, many times (perhaps thousands of times) in their lifetime. Therefore, the seal surfaces 250 and 236 of the component 220 and of the substrate 14, respectively, are configured to meet predetermined hardness requirements. When thus configured, the seal surfaces 236 and 250 effect a satisfactory seal with the C-seal 254, and also are durable enough to last through many iterations.

In known prior art modular systems, the components 220 and 14 are made of high quality and very hard wrought and machined stainless steel, such as alloy 316L. The components 220 and 14 are formed into substantially their final configuration, including the seal surfaces 250 and 236, by machining. The seal surfaces 250 and 236 are burnished, or polished, to a very high surface finish to provide an excellent seal surface for the C-seal 254, typically by electro-polishing or mechanical polishing. This type of mechanical polishing, or burnishing, effects a smoothing out of a surface, by taking material from higher areas and moving it into lower areas, to help minimize leak paths. For annular seal surfaces such as the seal surfaces 250 and 236, burnishing is typically done in a circumferential manner, that is, moving a tool in a circular pattern around the axis of the bore.

This aspect of the present invention is directed to reducing the cost of modular systems by, among other techniques, forming the first or second component or both by injection molding and sintering, or by casting, stainless steel such as alloy 316L, rather than by machining the components from wrought bar stock. Such a starting material can be significantly less expensive than wrought bar stock that is already hardened prior to machining. In addition, it can be substantially less expensive to cast or mold a part having the complex shape of the substrate 10.

However, sintered or cast stainless steel is not as hard a material as wrought stainless steel, and therefore it would be difficult to use a soft counterbore surface as a seal surface. In accordance with this aspect of the invention, then, a cast or molded stainless steel is work hardened so as to provide a sufficiently hard seal surface. Various different work hardening processes may be used, and in the exemplary embodiment herein the surfaces are work hardened by plastic deformation of the stainless steel alloy. Suitable work hardening techniques are known in the art; FIGS. 2A and 2B illustrate schematically one example.

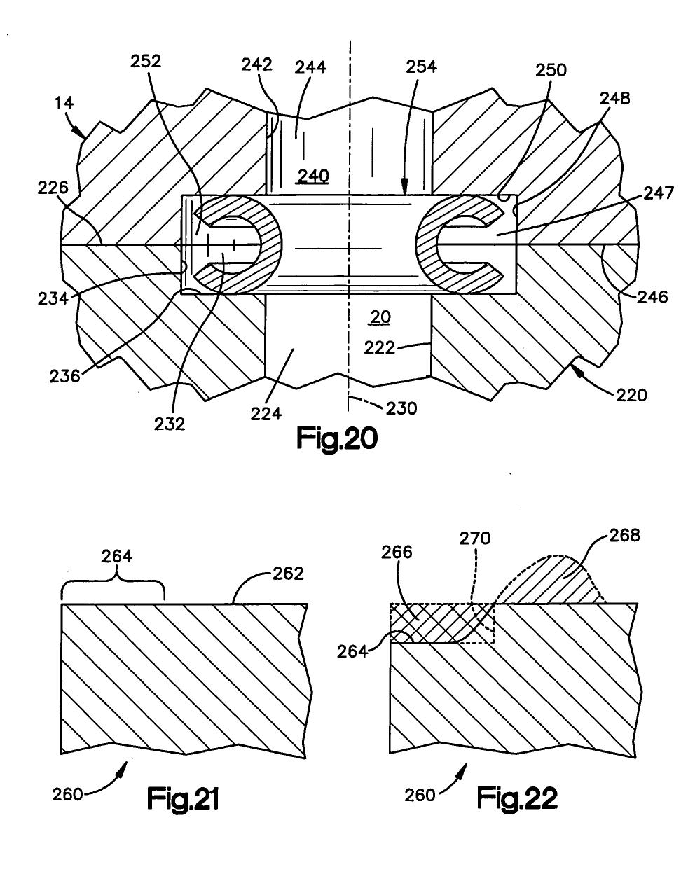

FIGS. 21 and 22 show in cross-section, one half of a port region of a component 260 that has been formed from cast or molded stainless steel for example. The component 260 may be any part that is intended to have a port for fluid communication with a passageway therein, for example, but not by way of limitation, the substrate 14 or the surface mount components described hereinabove.

In the example of FIGS. 21 and 22, the component 260 is first shown in FIG. 21 in an as molded or as cast condition without a counterbore, and with a surface 262. A die or other suitable tool (not shown) is then applied to a part of surface 262, here shown as surface 264, and the material plastically deformed to work harden the surface 264. The surface 264 can then be finished if required by secondary operations (for example, burnishing) to form a suitable seal surface in the component 260.

FIG. 22 illustrates how the plastic flow of the material causes work hardening of the cast material. The action of the tool (i.e., punch) causes material of volume 266 to flow radially outward (to the right as viewed in FIG. 22), thus resulting in an accumulation of material of equal volume 268. Final machining removes volume 268 and finishes the counterbore as shown by the dashed line 270. The work hardened seal surface 264 is thus formed.

With the seal surfaces thus formed in accordance with the present invention, a high quality series of metal seals is formed for the system 10. Specifically, the seal between the seal surface 250 (FIG. 20) on the component 220 and the C-seal 254 is a high quality metal to metal seal. Also, the seal between the C-seal 254 and the seal surface 236 on the component 14 is a high quality metal to metal seal. As a result, a high quality metal to metal to metal seal is provided in the system 10.

The metal flow caused by the tool is plastic deformation of the metal. As a result, the metal that is moved is hardened, so that the seal surface 264 (FIGS. 21 and 22) is work hardened. In addition, the material directly adjacent to the metal that is moved is also work hardened. The work hardening of the metal on which the seal surface is formed, extends for a distance below the seal surface itself. For example, it is believed that the illustrated work hardening process may harden the material below the seal surface for a depth roughly equal to the depth of the recess, or counterbore. This can help to increase the durability of the seal surface and thus of the component or substrate on which the seal surface is formed.

The metal flow caused by the tool has two effects. First, it shapes the metal body to form the seal surface (the recess, or counterbore, may be formed either first or at the same time as the seal surface). Second, it effects work hardening of the material of which the seal surface is formed. These two effects occur simultaneously. Thus, the single step of deforming the metal with the tool both forms the seal surface and work hardens it.

It may be desirable to deform the metal on which the seal surface is being formed, more than once. For example, the material may be deformed radially outward first, as described above, then radially inward, and possibly one or more times additional outward or inward. Such additional plastic deformation of the material can help to increase further the hardness of the seal surface.

In some systems it may be desired to use a sealing device other than a C-seal. One known sealing technique is the use of a flat, annular metal gasket that is compressed between two sealing beads, such as described in U.S. Pat. No. 3,521,910. In accordance with another embodiment of the invention, a cast or molded and sintered stainless steel component is work hardened to have a suitable sealing bead so that a flat annular metal gasket may be used in lieu of a C-seal, for example as shown in FIG. 23.

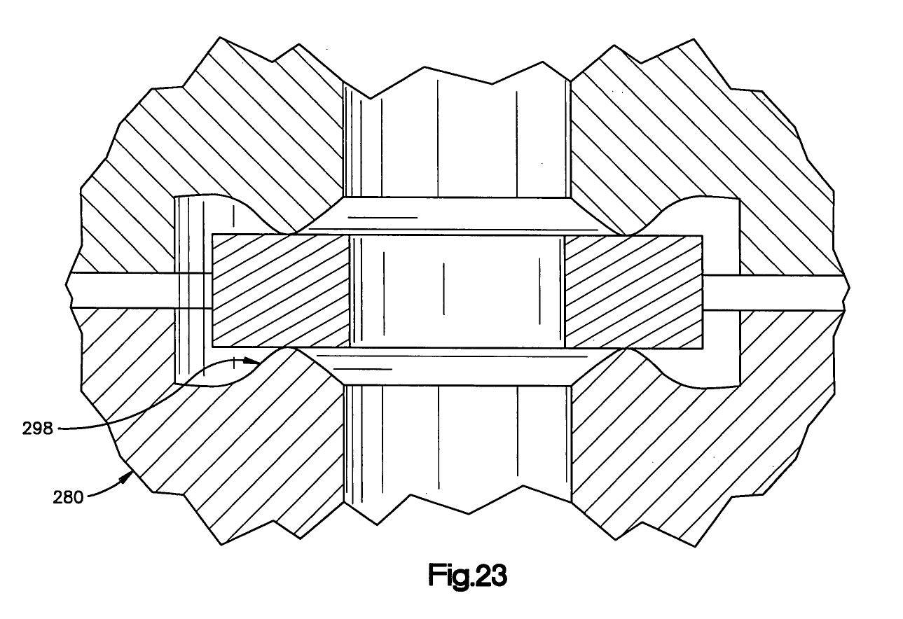

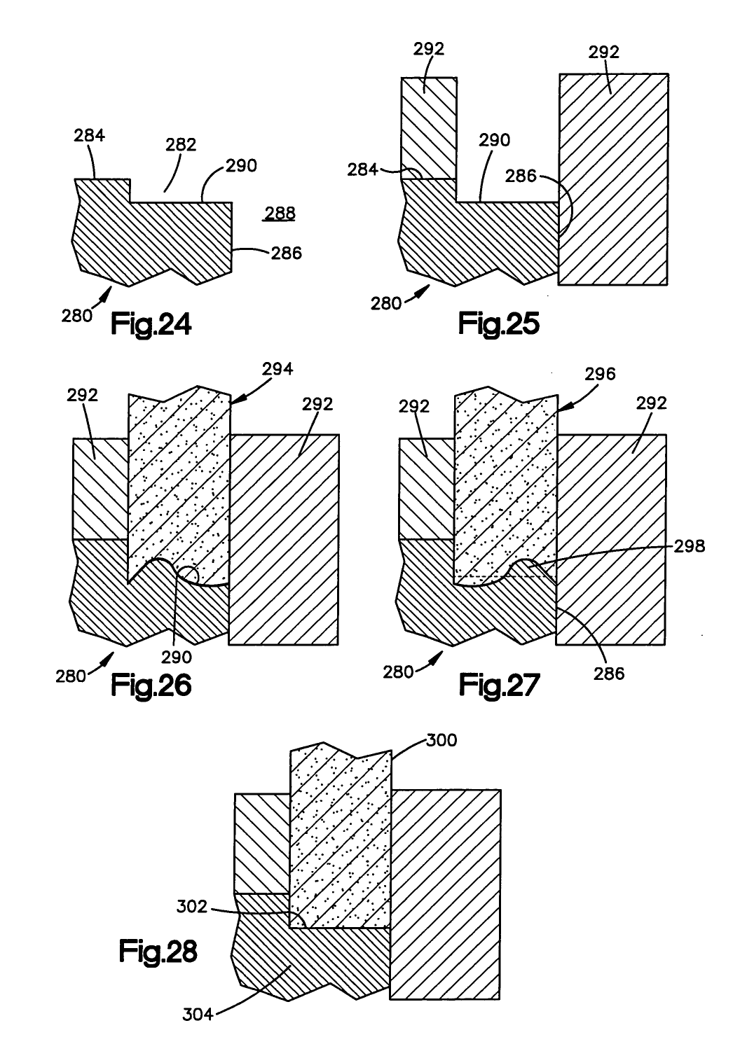

FIGS. 24-28 illustrate schematically one method for achieving this aspect of the invention. These figures illustrate only one half of the component body in longitudinal cross-section as is apparent from FIG. 23. In FIG. 24 a sintered and molded, or cast, stainless steel component 280 has been formed with a counterbore 282 formed in a surface 284 and an inner wall 286 that serves to define a fluid port 288. The counterbore 282 also provides a surface 290 that will eventually be formed into a seal surface.

In FIG. 25 a suitable tool or die 292 is positioned to support the surface 284 and the surface 286. The tool 292 may be made of any suitable material that is sufficiently strong and harder than the material of the component 280. In FIG. 22C an optional step may be performed—a first work hardening step carried out by applying a first die 294 to the surface 290 and plastically deforming the material of the component 280. In FIG. 27 a second or forming die 296 is used to further plastically deform the surface 290 to produce a final shape such as a sealing bead 298 that surrounds the port wall 286. The formed shape of the bead or seal surface 298 may be selected based on the particular seal to be used and overall design requirements and sealing requirements of the system. The number of work hardening steps used will depend on the desired hardness and finish requirements for the seal surface 298.

FIG. 28 illustrates an optional or alternative method of forming a seal surface in accordance with the invention. In FIG. 28, a tool or punch 300 is used to form a flat seal surface 302 on a component 304. The die 300 may be used after one or more radial flow working operations, for example, to flatten a bead such as the bead 298 (FIG. 27).

The work hardening of component 10 results from the plastic deformation of the stainless steel alloy (e.g., alloy 316L). Plastic deformation is obtained when stresses are applied that exceed the yield strength of the material. Work hardening of a metal can also be described as increasing the hardness of the metal by plastically deforming the metal below the recrystallization temperature range. In practice, steels are plastically deformed using processes such as cold heading, warm forming, forging, roll forming, bending, extruding, etc. Forming methods of particular interest to the disclosed principle of obtaining work hardened seal surfaces in molded and sintered, or cast, alloys are cold heading, warm forming, and roll forming.

As discussed above, it may be desirable to use a cast or molded stainless steel starting material, to form a component for use in the system 10. This can make the starting material less expensive. For example, metal injection molded (MIM) stainless steel 316 may have a hardness of about HRB (HRB refers to Rockwell Hardness B and HRC refers to Rockwell Hardness C as is well known in the art) in the low to high 60s. Cast and annealed material may have a hardness in the range of about HRB in the high 70s to low 90s. Strain hardened stainless steel 316 may have a hardness of about HRC 21-26.

A desirable hardness for the seal surface is a hardness of greater than about 300 Vickers or 30 HRC. Such a hardness is feasibly obtained by work hardening in accordance with the present invention.

The invention has been described with reference to the preferred embodiment. Modifications and alterations will occur to others upon a reading and understanding of this specification. It is intended to include all such modifications and alterations insofar as they come within the scope of the appended claims or the equivalents thereof.

1. A modular fluid system comprising:
first and second support members;
a substrate for connection with said first and second support members in an orientation generally transverse to an axis of said first and second support members;
said substrate having a fluid passage for directing fluid along a length of said substrate; and
a clamp for releasably clamping said substrate to one or more of said support members.

2. A system as set forth in claim 1 wherein said clamp comprises a blocking portion of said first support member and a drive block movable along the length of said first support member in a direction toward said blocking portion to clamp said substrate between said drive block and said blocking portion.

3. A system as set forth in claim 1 wherein a clamping force is directed generally along said axis of said first support member and generally perpendicular to said substrate.

4. A system as set forth in claim 1 wherein said substrate has opposite side surfaces and said clamp exerts a clamping force on said opposite side surfaces in a direction along said axis of said first support member.

5. The system of claim 1 wherein said substrate is secured to said support member by a compressive clamping force without a threaded engagement therebetween.

6. A modular fluid system comprising:
first and second support members;
a substrate for connection with said first and second support members in an orientation extending transverse to the length of said first and second support members;
said first and second support members being adapted to receive a plurality of said substrates at locations along the length of said first and second support members;
said substrate having a fluid passage for directing fluid along a portion of said substrate; and
a bolt movable between a first condition threaded in said first support member and securing said substrate tightly to said first support member and a second condition threaded in said first support member and enabling removal of said substrate from said first support member, without forming a threaded connection between said support member and substrate.

7. A system as set forth in claim 6 wherein said bolt does not extend through said substrate.

8. A system as set forth in claim 6 wherein said bolt moves axially as it is threadably rotated in said substrate, said system further comprising a wedge interposed between said bolt and said substrate and movable axially with said bolt.

9. A system as set forth in claim 8 further comprising a drive block interposed between said wedge and said substrate, said drive block moving in a direction transverse to the axial direction of movement of said wedge and parallel to the length of said first support member in response to axial movement of said bolt.

10. A modular fluid system comprising:
first and second elongate support members;
an elongate substrate for connection with said first and second support members in an orientation extending transverse to the length of said first and second support members;
said substrate having a fluid passage for directing fluid between along the length of said substrate; and
a wedge for releasably securing said substrate to said first support member.

11. A system as set forth in claim 10 wherein said wedge is movable in a first direction transverse to the length of said substrate and transverse to the length of said first support member to releasably secure said substrate to said first support member.

12. A system as set forth in claim 11 wherein said wedge cooperates with an inclined surface on said first support member to provide a first mechanical advantage in releasably securing said substrate to said first support member.

13. A system as set forth in claim 12 further including a threaded fastener for moving said wedge in the first direction to provide a second mechanical advantage in releasably securing said substrate to said first support member.

14. A system as set forth in claim 13 further including a bolt extending through said wedge and movable between a first condition threaded in said first support member and securing said wedge and said substrate tightly to said first support member and a second condition threaded in said first support member and enabling removal of said substrate from said first support member.

15. A method of assembling and disassembling selected parts of a gas supply system, said method comprising the steps of:
placing a substrate on a support member;
threading a bolt into the support member to releasably secure the substrate to the support member;
loosening the bolt without unthreading it from the support member; and
removing the substrate from the support member when the bolt is loosened but not unthreaded from the support member.

16. A method as set forth in claim 15 wherein said step of threading a bolt into the support member includes threading the bolt into the support member without moving the bolt through an opening in the substrate.

17. A method of assembling and disassembling selected parts of a modular fluid flow system, said method comprising the steps of:
placing a substrate on a support member; and
moving a member against said substrate to apply a releasable force to secure said substrate to said support member without a threaded connection therebetween.

18. A method as set forth in claim 17 wherein said step of moving a member comprises moving a wedge in a first direction relative to the support member and causing the substrate to be clamped in a second direction relative to the support member that is transverse to the first direction.

19. A modular fluid system comprising:
first and second support members;
a substrate for connection with said first and second support members in an orientation generally transverse to an axis of said first and second support members;
said substrate having a fluid passage therein; and
means for applying a releasable force to secure said substrate to one or more of said support members without a threaded engagement between said substrate and said one or more support members.

20. A modular fluid system comprising:
generally parallel first and second support members spaced apart from each other and defining a plurality of substrate locations spaced apart by a predetermined distance along the length of said support members;
a substrate engageable with said first and second support members to place said substrate in a selected one of said plurality of substrate locations extending between said first and second support members, said substrate having a component mounting surface and a plurality of component mounting locations; and
at least one fluid flow component mountable on said component mounting surface of said substrate at a selected one of said component mounting locations;
said substrate having an overall first width as defined by outer surfaces of said substrate that is equal to or less than said predetermined distance;
said substrate having a second width, less than said first width, at selected areas along the length of said substrate between said first and second end portions of said substrate.

21. A system as set forth in claim 20 wherein said selected areas of said substrate are within said component mounting locations.

22. A system as set forth in claim 20 wherein each one of said component mounting locations is defined by a set of fastener openings in said substrate for receiving fasteners for fastening said at least one fluid flow component to said substrate.

23. A system for supplying fluid to a plurality of fluid flow components such as valves, filters, mass flow controllers and the like each having an inlet port and an outlet port, said system comprising:
first and second support members each having a plurality of mounting locations; and
a substrate mountable to said first and second support members;
said substrate having a flow passage formed in a central portion thereof;
said substrate having a plurality of component mounting portions extending laterally outward from said central portion for supporting flow components mounted on said substrate;
air flow passageways formed between adjacent ones of said component mounting portions.

24. A substrate for a modular fluid flow system, said substrate being adapted to support one or more surface mount components thereon, the substrate comprising:
a main body with one or more flow passages formed therein;
a plurality of component mounting portions extending laterally outward from said main body for supporting flow components mountable thereon;
air flow passageways formed between adjacent ones of said component mounting portions.

25. The substrate of claim 24 comprising cast metal.

26. A valve comprising:
a valve base having a surface;
first and second fluid flow ports in said surface; said first and second fluid flow ports being collinear with each other along an axis;
a third port in said surface, said third port being positioned other than collinear with said axis; and
a passage in said valve through which said third port can be selectively connected in fluid communication with one or more of said first and second ports in said valve base.

27. A valve as set forth in claim 26 wherein said valve is operable between the closed and open conditions by movement of a diaphragm inside said valve.

28. A valve as set forth in claim 27 for mounting on a substrate that has one or more sets of two ports along its length, each set of two ports on the substrate being adapted to communicate with said first and second ports of the valve when mounted thereon.

29. A valve as set forth in claim 28 wherein the substrate has a plurality of identical predetermined mounting locations for supporting fluid components, each one of the mounting locations having exactly two ports that connect with the fluid channel in the substrate, and wherein said valve base has a plurality of fastener openings for receiving fasteners for fastening said valve to the substrate at a selected one of the mounting locations of the substrate in a fastened condition in which said collinear first and second ports in said mounting surface of said valve base overlie the exactly two ports in the selected mounting location of the substrate and said third port in said mounting surface of said valve base does not overlie the substrate.

30. A valve comprising:
a valve body with a surface thereon; and three co-planar fluid ports formed in said surface and that are not collinear with respect to each other.

31. The valve of claim 30 wherein one of said three fluid ports is a purge port for the valve.

32. The valve of claim 30 wherein said valve comprises cast metal.

33. A method of forming a component having a seal surface, said method comprising the steps of:
providing a metal body having a first portion on which a seal surface is to be formed surface and having an adjacent second portion; and
work hardening the first portion of the metal body to form the seal surface of the component.

34. A method as set forth in claim 33 wherein said step of work hardening includes deforming the first portion of the metal body with at least one deforming member thereby to form the seal surface of the component.

35. A method as set forth in claim 34 wherein said step of work hardening includes deforming the first portion of the metal body sequentially with at least first and second deforming members thereby to form the seal surface of the component.

36. A method as set forth in claim 33 wherein said step of work hardening the first portion of the metal body to form the seal surface of the component comprises forming a seal surface on a recessed portion of the component.

37. A method as set forth in claim 33 wherein said step of providing a metal body includes providing a metal body that is formed as one piece including the first portion and the second portion.

38. A method as set forth in claim 37 wherein said step of providing a metal body includes providing a metal body that is formed by casting, or by pressing and sintering, or by molding and sintering.

39. A method of forming a component having a seal surface, said method comprising the steps of:
forming a metal body with a first hardness;
forming a recess in the metal body; and
forming a seal surface on the recess with a second hardness that is greater than the first hardness.

40. A method as set forth in claim 39 wherein said step of forming a seal surface with a second hardness includes work hardening the seal surface.

41. The method of claim 40 wherein the work hardening is coining.

42. The method of claim 40 wherein the work hardening is punching.

43. The method of claim 40 wherein said work hardening is performed in a single step.

44. The method of claim 40 wherein said work hardening is performed in multiple steps.

45. A method as set forth in claim 40 wherein said step of forming a seal surface with a second hardness includes work hardening the seal surface with a tool that simultaneously forms the seal surface.

46. A method as set forth in claim 39 wherein said step of forming a metal body with a first hardness includes forming the metal body by casting, or by pressing and sintering, or by molding and sintering.

47. A method of forming a component having a seal surface of a first hardness sufficient to provide an effective metal to metal seal, said method comprising the steps of:
providing a metal body having a seal surface of the first hardness; and
work hardening the seal surface to a second hardness that is greater than the first hardness.

48. An element for a fluid control system, said element having a fluid flow passage and having a seal surface, said element being made from a metal body having a first portion and having an adjacent second portion including the seal surface, said second portion of the metal body being work hardened to a hardness greater than the hardness of the first portion of the metal body to form the seal surface of the element.

49. The element of claim 48 wherein said seal surface comprises a raised bead.
